(19) United States
(12) Patent Application Publication
(10) Pub. No.: US 2014/0062448 A1
(43) Pub. Date: Mar. 6, 2014

(54) VOLTAGE LEVEL CONVERTING CIRCUIT AND ELECTRONIC DEVICE USING THE SAME

(71) Applicant: HON HAI PRECISION INDUSTRY CO., LTD., New Taipei (TW)

(72) Inventor: CHENG-KUANG MI, New Taipei (TW)

(21) Appl. No.: 13/929,811

(22) Filed: Jun. 28, 2013

(30) Foreign Application Priority Data
Aug. 29, 2012 (TW) 101131302

(51) Int. Cl. H02M 3/157

(52) U.S. Cl. CPC H02M 3/157
USPC 323/311

(57) ABSTRACT

A circuit for an electronic device translates logic-low and logic-high voltage levels into other voltage levels suitable for digital intercommunication between the host electronic device and external devices, and between different external devices. The circuit comprises a power supply, a processing module, a communicating module, and a voltage converting module. The power supply provides a first voltage, a second voltage, and a pulse voltage with a predetermined duty cycle. The voltage level converting module converts incoming or outgoing logic voltage levels between a first mode and a second or more modes.

### BACKGROUND

1. Technical Field

The present disclosure relates to an electronic device with a voltage level converting circuit.

2. Description of Related Art

Electronic devices include a voltage level converting chip for converting internal logic levels (such as transistor-transistor logic (TTL)) to standard interface line levels (such as RS-232 voltage levels) for transmitting through a serial port. For example, in the TTL logic mode, the logic voltage level of “1” is a voltage ranging from 3.6˜5V, and the logic voltage level “0” is a voltage ranging from 0˜2.4V; in the RS-232 logic mode, the logic voltage level “0” is a voltage ranging from 3˜15V, and the logic voltage level “1” is a voltage ranging from −3˜15V. The voltage level converting chip is an integrated circuit, a complicated circuit with a plurality of electronic parts. However, a new chip is needed when one of internal electronic parts in the chip is damaged.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an electronic device in accordance with one embodiment.

FIG. 2 is a circuit diagram of the electronic device of FIG. 1 in accordance with one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at “least one.”

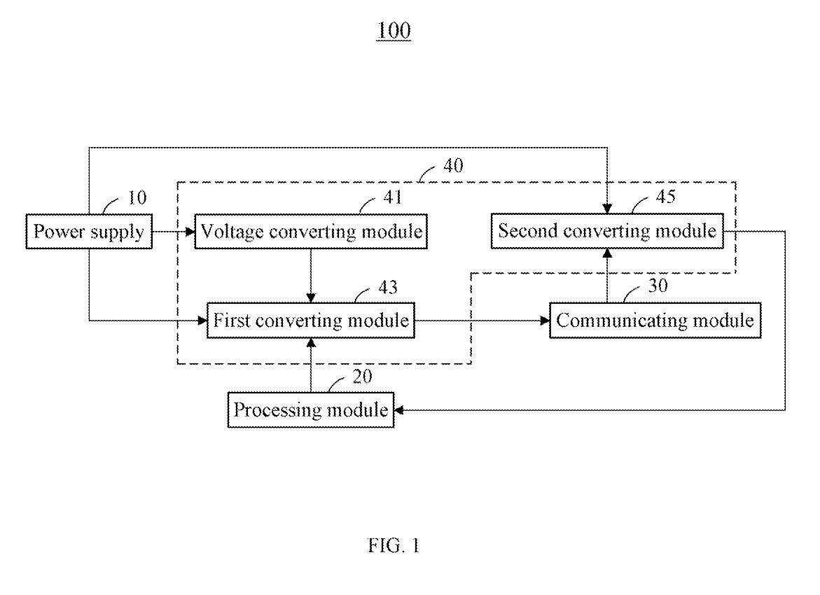

FIG. 1 shows an electronic device 100 of one embodiment of the present disclosure. The electronic device 100 includes a power supply 10, a processing module 20, a communicating module 30, and a voltage level converting circuit 40. The electronic device 100 is capable of converting between logic voltage levels, from a first mode to a second mode and vice versa. In the embodiment, the electronic device 100 can be a computer or a TV, for example; the first mode is an internal logic level mode, such as the TTL mode, and the second mode is a standard interface line level mode, such as the RS-232 voltage level mode.

The power supply 10 provides a first voltage, a second voltage, and a pulse voltage with a predetermined duty cycle to the voltage level converting circuit 40 when the electronic device 100 is powered on. The first voltage is higher than the second voltage. In the embodiment, the power supply 10 is an internal battery.

The processing module 20 is capable of generating or receiving logic voltage levels in the first mode.

The communicating module 30 is capable of outputting logic voltage levels in the second mode. In the embodiment, the communicating module 30 is a serial port, such as a RS232 port.

The voltage level converting circuit 40 is connected between the processing module 20 and the communicating module 30 and receives the first voltage, the second voltage, and the pulse voltage from the power supply 10. The voltage level converting circuit 40 converts the logic voltage levels between the first mode and the second mode. The voltage level converting circuit 40 comprises a voltage converting module 41, a first converting module 43, and a second converting module 45. The voltage converting module 41 converts the received pulse voltage into a third voltage.

The first converting module 41 converts the logic voltage levels in the first mode generated by the processing module 20 into the logic voltage levels in the second mode based on the first voltage, the second voltage, and the third voltage, and transmits the logic voltage levels in the second mode to the communicating module 30. The second voltage is larger than the third voltage.

The second converting module 45 converts the logic voltage levels in the second mode received through the communicating module 30 into the logic voltage levels in the first mode based on the second voltage, and transmits logic voltage levels in the first mode to the processing module 20.

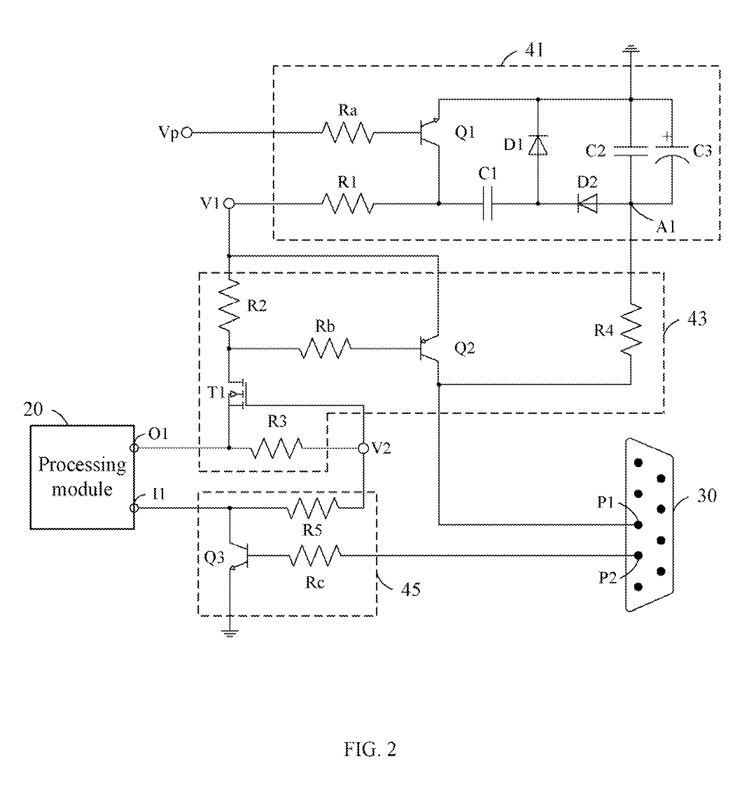

Referring to FIG. 2, the power supply 10 includes a first voltage terminal V1, a second voltage terminal V2, and a pulse voltage terminal Vp. The first voltage terminal V1 outputs the first voltage, the second voltage terminal V2 outputs the second voltage, and the pulse voltage terminal Vp outputs the pulse voltage. In the embodiment, the first voltage is 5V, the second voltage is 3.3V, the logic high voltage level of the pulse voltage is 5V, and the logic low voltage level of the pulse voltage is 0V.

The processing module 20 includes an input terminal I1 and an output terminal O1. The input terminal I1 is connected to the second converting module 45, and the output terminal O1 is connected to the first converting module 43.

The communicating module includes an input pin P1 and an output pin P2. The input pin P1 is connected to the output terminal O1 through the second converting module 43, and the output pin P2 is connected to the input terminal I1 through the first converting module 45.

The voltage converting module 41 includes a first transistor Q1, a first pull-up resistor R1, a first resistor Ra, a first capacitor C1, a second capacitor C2, an electrolytic capacitor C3, a first diode D1, a second diode D2, and a node A1. A base of the first transistor Q1 is connected to the pulse voltage terminal Vp through the first resistor Ra. An emitter of the first transistor Q1 is grounded. A collector of the first transistor Q1 is connected to the first voltage terminal V1 through the first pull-up resistor R1. An anode of the first diode D1 is connected to the collector of the first transistor Q1 through the first capacitor C1. A cathode of the first diode D1 is connected to the emitter of the first transistor Q1. An anode of the second diode D2 is connected to the first converting module 43. A cathode of the second diode D2 is connected to the collector of the first transistor Q1 through the first capacitor C1. Opposite terminals of the second capacitor C2 are connected to the anode of the second diode D2 and the emitter of the first transistor Q1. An anode of the electrolytic capacitor C3 is connected to the emitter of the first transistor Q1, and a cathode of the electrolytic capacitor C3 is connected to the anode of the second diode D2 through the node A1. In the embodiment, the first transistor Q1 is an npn type bipolar junction transistor; the capacitance of the electrolytic capacitor C3 is ten times more than the capacitance of the first capacitor C1.

The first converting module 43 includes a MOSFET (metal oxide semiconductor field effect transistor) T1, a second transistor Q2, a second pull-up resistor R2, a third pull-up resistor R3, a fourth pull-up resistor R4, and second resistor Rb. A gate of the MOSFET T1 is connected to the second voltage terminal V2. A source of the MOSFET T1 is connected to the output terminal O1. A drain of the MOSFET T1 is connected to the first voltage terminal V1 through the second pull-up transistor R2. A base of the second transistor Q2 is connected to the drain of the MOSFET T1 through the second resistor Rb. An emitter of the second transistor Q2 is connected to the first voltage terminal V1. A collector of the second transistor Q2 is connected to the input pin P1. Opposite ends of the fourth pull-up transistor R4 are respectively connected to the anode of the second diode D2 and the collector of the second transistor Q2. In the embodiment, the MOSFET T1 is an n-channel enhancement type metal oxide semiconductor field effect transistor; the second transistor Q2 is a pnp type bipolar junction transistor.

The second converting module 45 includes a third transistor Q3, a fifth pull-up resistor R5, and a third resistor Rc. A base of the third transistor Q3 is connected to the output pin P2 through the third resistor Rc. An emitter of the third transistor Q3 is grounded. A collector of the third transistor Q3 is connected to the input pin P1. Opposite terminals of the fifth pull-up resistor R5 are connected to the collector of the third transistor Q3 and the second voltage terminal V2. In the embodiment, the third transistor Q3 is an npn type bipolar junction transistor.

When the pulse voltage is in a low level, the difference between the base and the emitter of the first transistor Q1 is less than 0.7V, and the first transistor Q1 is turned off. The first diode D1 is turned on and the second diode D2 is turned off. The first pull-up resistor R1, the first capacitor C1, the first diode D1, and the electrolytic capacitor C3 form a charging path to charge the electrolytic capacitor C3. Based on the first voltage, the voltage difference between the anode and the cathode of the electrolytic capacitor C3 is 5V when the charging processing is ended. As the anode of the electrolytic capacitor C3 is grounded, the voltage at node A1, i.e. the third voltage, is −5V. When the pulse voltage is at the high level, the difference between the base and the emitter of the first transistor Q1 is more than 0.7V, the first transistor Q1 is turned on and the voltage at the collector of the transistor Q1 is almost 0V. The first diode D1 is turned off and the second diode D2 is turned on. The electrolytic capacitor C3, the second diode D2, the first capacitor C1, the collector of the first transistor Q1, and the emitter of the first transistor Q2 form a discharging path. The cathode of the electrolytic capacitor C3 provides the third voltage to the first converting module 43 through the node A1. Based on the pulse voltage of the predetermined duty cycle, the third voltage will always be −5V.

When the output terminal O1 generates a logic high voltage level in the first mode, the different between the gate and the source of the MOSFET T1 is less than 0.7V, and the MOSFET T1 is turned off. The voltage at the base of the second transistor Q2 is equal to the first voltage outputted by the first voltage terminal V1. The difference between the base and the emitter of the second transistor Q2 is less than 0.7V, thus the second transistor Q2 is turned off. The voltage of the input pin P1 is equal to the third voltage, as a logic high voltage level in the second mode. When the output terminal 01 generates a logic low voltage level in the second mode, the difference between the gate and the source of the MOSFET T1 is more than 0.7V, and the MOSFET T1 is turned on. The base of the second transistor Q2 is grounded, thus the difference between the base and the emitter of the second transistor Q2 is more than 0.7V. The second transistor Q2 is turned on. The voltage of the input pin P1 is equal to the first voltage outputted by the first voltage terminal V1, as a logic low voltage level in the second mode. Thus, the logic voltage levels in the first mode generated by the output terminal O1 are converted into the logic voltage levels in the second mode received by the input pin P1.

When the output pin P2 generates a logic high voltage level in the second mode, the different between the base and the emitter of the third transistor Q3 is less than 0.7V, thus the third transistor Q3 is turned off. The voltage of the input terminal I1 is equal to the second voltage outputted by the second voltage terminal V2, as the logic high voltage level in the first mode. When the output pin P2 generates a logic low voltage level in the second mode, the difference between the base and the emitter of the third transistor Q3 is more than 0.7V, and the third transistor Q3 is turned on. The input terminal I1 is grounded, as a logic low voltage level in the first mode. Thus, the logic voltage levels in the second mode generated by the output pin P1 are converted into the logic voltage levels in the first mode which is received by the input terminal I1.

When any internal parts of the voltage level converting circuit 40 are damaged, only the damaged/non-functioning part(s) must be replaced, there is no need to replace the whole voltage level converting circuit 40. Therefore, the voltage level converting circuit 40 is simpler, and the cost for repairing a voltage level converting circuit 40 is reduced.

It is to be understood, however, that even though information and advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device capable of communicating with external devices, comprising:
a power supply adapted to provide a first voltage, a second voltage, and a pulse voltage with a predetermined duty cycle;
a processing module;
a communicating module; and
a voltage level converting module adapted to convert logic voltage levels between a first mode and a second mode;
wherein the voltage level converting module comprises a voltage converting module and a first converting module; the voltage level converting module converts the pulsed voltage into a third voltage; the first converting module converts the logic voltage levels in the first mode generated by the processing module to the logic voltage levels in the second mode to transmit to the external devices through the communicating module based on the first voltage, the second voltage, and the third voltage.

2. The electronic device of claim 1, wherein the voltage converting circuit further comprises a second converting module; the communicating module receives the logic voltage in the second mode from the external devices; the second converting module converts the logic voltage levels in the second mode received by the communicating module into the logic voltage levels in the first mode to transmit to the processing module based on the second voltage.

3. The electronic device of claim 1, wherein the power supply comprises a first voltage terminal and a pulse voltage terminal; the voltage converting module comprises a first transistor, a first pull-up resistor, a first capacitor, a second capacitor, an electrolytic capacitor, a first diode, and a second diode; a base of the first transistor is connected to the pulse voltage terminal; an emitter of the first transistor is grounded; a collector of the first transistor is connected to the first voltage terminal through the first pull-up resistor; an anode of the first diode is connected to the collector of the first transistor through the first capacitor; a cathode of the first diode is connected to the emitter of the first transistor; an anode of the second diode is connected to the first converting module; a cathode of the second diode is connected to the collector of the first transistor through the first capacitor; two opposite ends of the second capacitor are respectively connected to the anode of the second diode and the emitter of the first transistor; an anode of the electrolytic capacitor is connected to the emitter of the first transistor, and a cathode of the electrolytic capacitor is connected to the anode of the second diode.

4. The electronic device of claim 3, wherein the capacitance of the electrolytic capacitor is ten times more than the capacitance of the first capacitor.

5. The electronic device of claim 2, wherein the processing module comprises an input terminal and an output terminal; the communicating module includes an input pin and an output pin; the input pin is connected to the output terminal through the second converting module, and the output pin is connected to the input terminal through the first converting module.

6. The electronic device of claim 5, wherein the first converting module comprises a metal oxide semiconductor field effect transistor (MOSFET), a second transistor, a second pull-up resistor, a third pull-up resistor, a fourth pull-up resistor; a gate of the MOSFET is connected to the second voltage terminal, a source of the MOSFET is connected to the output terminal, a drain of the MOSFET is connected to the power supply through the second pull-up transistor; a base of the second transistor is connected to the drain of the MOSFET, an emitter of the second transistor is connected to the power supply, a collector of the second transistor is connected to the input pin; two opposite end of the fourth pull-up transistor are respectively connected to the anode of the second diode and the collector of the second transistor.

7. The electronic device of claim 5, wherein the second converting module comprises a third transistor and a fifth pull-up resistor; a base of the third transistor is connected to the output pin, an emitter of the third transistor is grounded, a collector of the third transistor is connected to the input pin; two opposite ends of the fifth pull-up resistor are respectively connected to the collector of the third transistor and the power supply.

8. A voltage level converting circuit connected between a processing module and a communicating module, and received a first voltage, a second voltage, and a pulse voltage with a predetermined duty cycle from a power supply; the voltage level converting circuit comprising:
a voltage converting module adapted to convert the pulsed voltage into a third voltage; and
a first converting module adapted to receive a first voltage, a second voltage, and the third voltage;
wherein the first converting module converts logic voltage levels in a first mode generated by the processing module to logic voltage levels in a second mode to transmit to the communicating module.

9. The voltage level converting circuit of claim 8, wherein the voltage converting circuit further comprises a second converting module; the second converting module converts the logic voltage levels in the second mode received by the communicating module into the logic voltage levels in the first mode to transmit to the processing module based on the second voltage.

10. The voltage level converting circuit of claim 8, wherein the power supply comprises a first voltage terminal and a pulse voltage terminal; the voltage converting module comprises a first transistor, a first pull-up resistor, a first capacitor, a second capacitor, an electrolytic capacitor, a first diode, and a second diode; a base of the first transistor is connected to the pulse voltage terminal; an emitter of the first transistor is grounded; a collector of the first transistor is connected to the first voltage terminal through the first pull-up resistor; an anode of the first diode is connected to the collector of the first transistor through the first capacitor; a cathode of the first diode is connected to the emitter of the first transistor; an anode of the second diode is connected to the first converting module; a cathode of the second diode is connected to the collector of the first transistor through the first capacitor; two opposite ends of the second capacitor are respectively connected to the anode of the second diode and the emitter of the first transistor; an anode of the electrolytic capacitor is connected to the emitter of the first transistor, and a cathode of the electrolytic capacitor is connected to the anode of the second diode.

11. The voltage level converting circuit of claim 10, wherein the capacitance of the electrolytic capacitor is ten times more than the capacitance of the first capacitor.

12. The voltage level converting circuit of claim 10, wherein the first transistor is an npn type bipolar junction transistor.

13. The voltage level converting circuit of claim 9, wherein the processing module comprises an input terminal and an output terminal; the communicating module includes an input pin and an output pin; the input pin is connected to the output terminal through the second converting module, and the output pin is connected to the input terminal through the first converting module.

14. The voltage level converting circuit of claim 13, wherein the first converting module comprises a metal oxide semiconductor field effect transistor (MOSFET), a second transistor, a second pull-up resistor, a third pull-up resistor, a fourth pull-up resistor; a gate of the MOSFET is connected to the second voltage terminal, a source of the MOSFET is connected to the output terminal, a drain of the MOSFET is connected to the power supply through the second pull-up transistor; a base of the second transistor is connected to the drain of the MOSFET, an emitter of the second transistor is connected to the power supply, a collector of the second transistor is connected to the input pin; two opposite end of the fourth pull-up transistor are respectively connected to the anode of the second diode and the collector of the second transistor.

15. The voltage level converting circuit of claim 14, wherein the MOSFET is an n-channel enhancement type metal oxide semiconductor field effect transistor; the second transistor is a pnp type bipolar junction transistor.

16. The voltage level converting circuit of claim 13, wherein the second converting module comprises a third transistor and a fifth pull-up resistor; a base of the third transistor is connected to the output pin, an emitter of the third transistor is grounded, a collector of the third transistor is connected to the input pin; two opposite ends of the fifth pull-up resistor are respectively connected to the collector of the third transistor and the power supply.

17. The voltage level converting circuit of claim 16, wherein the third transistor is an npn type bipolar junction transistor.

18. The voltage level converting circuit of claim 8, wherein the first voltage is larger than the second voltage; the second voltage is larger than the third voltage.
